(19) United States
(12) Patent Application Publication
(10) Pub. No.: US 2008/0060741 A1
(43) Pub. Date: Mar. 13, 2008

(54) Ultrasonically Bonded Nonwoven Permeable Pouch

(76) Inventors: Marc P. Privitera, Walnut Creek, CA (US); Scott A. Wood, Livermore, CA (US); Nancy Falk, Livermore, CA (US); Gregory Van Buskirk, Danville, CA (US); David J. Lestage, Livermore, CA (US)

Correspondence Address: THE CLOROX COMPANY, P.O. BOX 24305, OAKLAND, CA, 94623-1305, US

(21) Appl. No.: 11/470,722

(22) Filed: Sep. 7, 2006

(51) Int. Cl. B32B 27/00

(52) U.S. Cl. 156/73.1; 428/411.1

(57) ABSTRACT

An article that provides for the controlled release of an active substance is provided. The article features a plurality of polymeric membranes. The plurality of polymeric membranes are ultrasonically bonded to form at least one welded seal defining a bonded compartment hosting at least one active substance, where the ultrasonic welded seal exhibits a controlled positive permeability for the active substance.

### BACKGROUND OF THE INVENTION

1. Field of the Invention

The field of the invention relates to articles for controlled release of various substances into fluid environments generally, and more particularly to articles featuring a plurality of welded polymeric membranes for containing, transporting and controlled release of various substances from a contained source into a surrounding fluid environment.

2. Background

A number of applications exist in which various substances are desired to be dispensed into fluid environments, particularly into aqueous environments. Further, many such applications seek a controlled release function to slowly release such substances over a desired period of time. Such applications include, for example, chemical substance addition to drinking water, swimming pools, spas, water fountains, fluid supply stocks, water circulation systems, as well as release of compositions of more than one substance added to treatment baths and cleaning liquors employed for home, business and commercial usage, such as for use in washing machines, dishwashers, wash tubs, buckets and the like. A variety of other applications for releasing substances into desired fluids exist today. Many employ the use of permeable membranes to achieve a controlled release function of the desired substances contained within articles or pouches featuring at least one membrane having permeable characteristics with respect to the desired substances.

One problem that exists in implementing such applications is the difficulty in controllably dispensing such substances at a desired rate. Articles comprising polymeric membranes, bonded with a plurality of welded seals that defines a plurality of bonded compartments, are known in the art. In these articles, one or more bonded compartments provide an enclosed volume for containing one or more substances or compositions. The enclosed substances are exposed to the environment by fully or partially removing the polymeric membranes, or rupturing them in some fashion at the time and point of use to effect release of the contents to the system. This approach is generally employed in packages whose contents are to be released in their entirety, and all seals employed in constructing the pouch or in sealing an article with a rupturable membrane are bonded seals featuring a complete sealing that does not allow any permeation of the contained substances.

For controlled release articles, polymeric membranes having a selected permeability to one or more of the substances are employed so that the desired substance is released at a rate solely determined by the permeability of the one or more membranes of construction. In this approach, the conventional process for sealing the plurality of polymeric membranes is also to produce a bonded seal with complete sealing that does not allow any permeation of the contained substances through the seal itself. This approach necessitates the use of at least one permeable membrane portion. However, the variation in the process of welding sometimes causes variation in the bonded seal that may lead to uncontrolled permeation of the contained substances in the form of gas, vapors or solution. The contained substances may then be released without effective control of the release rate. As a result, bonding is generally augmented by producing an extensive bonding region or multiple concentric bonding regions to ensure complete sealing of all welded seams to ensure that release of the desired substance is effective only through the membrane material.

This approach necessitates the use of permeable membranes to achieve controlled release. These materials are generally expensive compared to non-permeable membranes, and their controlled release profiles are pre-selected at the time of manufacture of the membrane, rather than during formation of the article of construction. Accordingly, no change in permeation rate or tuning of the overall permeability of the article is possible during construction of the article because the release characteristics of the article are solely determined by the nature of the selected permeable membrane material employed. Further, many permeable membranes rely on the presence of a plurality of uniform pores to achieve the desired controlled release rate, so that the density and physical characteristics of the membrane are limited by the selection of the desired release characteristics. Further, other permeable membranes rely on hydrophobic and hydrophilic chemical modifications to provide selected water, vapor and substance diffusion rates such that the rate of permeation is dependent on the chemical properties of the substances to be released, so that compositions with multiple substances present may not release those individual substances at a similar rate, resulting in an undesirable variable release profile with respect to the substances of the composition.

Some products available in the market solve one or more of the above problems. Examples of such products include pouches with either perforated or porous permeable polymeric sheets, or multiple compartment pouches where multiple substances are housed separately in order to achieve the desired controlled release characteristics of one or more active substances simultaneously.

In light of the above discussion, there is a need for articles that can controllably release a substance present in the article, with an adjustable but predetermined rate and quantity, without necessitating the use of permeable membranes. Further, a means to allow control and selection of a permeation rate not dependent on the permeability of the membrane material of construction, so as to allow tuning of the permeation during manufacture of the final article, would be most desirable.

### SUMMARY

In view of the foregoing discussion, the present invention provides an article for containing an active substance, the article allowing a controlled release of the active substance into a surrounding environment across a bonded seal in the article. The bonded seals of the article are produced in a manner that allowed permeation of the active substance in a controlled manner through a bonded region of the seal. The process of ultrasonic welding is employed to produce an ultrasonically bonded seal for the article. The ultrasonically bonded seal, produced by an ultrasonic welding process, has a positive controlled permeability for the active substance across the bonded region of the seal formed by the ultrasonic welding process.

In an embodiment of the present invention, the article features one or more polymeric membranes. The polymeric membranes feature one or more non-woven polymeric materials. The article features at least one ultrasonically welded seal, wherein the at least one ultrasonically welded seal forms a bonded region that bonds the one or more polymeric membranes. The at least one ultrasonically welded seal has a positive controlled permeability for an active substance stored in a compartment formed in the article by formation of an interior region defined by the one or more polymeric membranes and an ultrasonically welded seal. The movement of the active substance across the at least one ultrasonically welded seal defines the positive controlled permeability for the active substance. The ultrasonically welded seal features a plurality of tortuous free paths within the bonded region formed between the one or more polymeric membranes. The plurality of tortuous free paths allows the movement of the active substance across the at least one ultrasonically welded seal within the bonded region exhibiting the positive controlled permeability.

The scope of the present invention also includes an ultrasonic welding process for producing the bonded seal of the article for containing one or more active substances. The method consists of using one or more polymeric membranes for forming one or more bonded compartments that include the one or more active substances. Parts of two or more of the one or more polymeric membranes are bonded in an ultrasonic weld station to obtain an ultrasonically welded seal. Process parameters of the ultrasonic welding process are pre-selected to produce the ultrasonically welded seal with the desired controlled positive permeability for the one or more active substances.

Further, the scope of the present invention includes a method of containing and controllably releasing one or more active substances to a surrounding environment. The method consists of manufacturing an article for containing one or more active substances in one or more bonded compartments. The article features one or more ultrasonically welded seals with positive controlled permeability for one or more active substances. The article is placed in an environment, where the one or more active substances are released from the one or more bonded compartments at a rate determined by the positive controlled permeability of each of the one or more ultrasonically welded seals.

### OBJECTS OF THE INVENTION

One object of the invention is an article for controllably releasing an active substance, the article comprising: (a) one or more polymeric membranes comprising one or more polymeric materials; (b) at least one ultrasonically welded seal, wherein the at least one ultrasonically welded seal forms a bonded region in the one or more polymeric membranes, the at least one ultrasonically welded seal having a positive controlled permeability for the active substance; and (c) optionally, one or more active substances, wherein movement of the active substance across the at least one ultrasonically welded seal defines the positive controlled permeability for the active substance.

In another object of the invention is provided a method for producing an article for controllably releasing an active substance, the method comprising: (a) using one or more polymeric membranes for forming one or more of bonded regions, the one or more bonded regions defining at least one bonded compartment, the at least one bonded compartment providing an enclosed interior volume for containing the active substance; and (b) bonding parts of two or more of the one or more polymeric membranes to obtain an ultrasonically welded seal using an ultrasonic weld station, wherein the ultrasonically welded seal has a positive controlled permeability for the active substance.

In a further object of the invention is a method for producing an article for controllably releasing an active substance, the method comprising: (a) using one or more polymeric membranes to create a bonded compartment defining an enclosed interior volume for containing the active substance; (b) feeding the one or more polymeric membranes between an anvil and a horn of an ultrasonic weld station; (c) producing an ultrasonic frequency imparting an ultrasonic energy to the one or more polymeric membranes, the ultrasonic frequency being produced by the horn; and (d) engaging the horn and the anvil to obtain an ultrasonically welded seal, wherein the ultrasonically welded seal bonds parts of the one or more polymeric membranes, the ultrasonically welded seal having a positive controlled permeability for the active substance.

In yet another object of the invention is a method of containing and controllably releasing one or more active substances to a surrounding environment comprising: (a) forming an article containing one or more active substances, wherein the article comprises one or more polymeric membranes comprised of one or more polymeric materials, and at least one ultrasonically welded seal, wherein the at least one ultrasonically welded seal forms a bonded region in the one or more polymeric membranes, the at least one ultrasonically welded seal having a positive controlled permeability for the one or more active substances, wherein movement of the one or more active substances across the at least one ultrasonically welded seal defines the positive controlled permeability of the one or more active substances; (b) placing the one or more active substances within one or more bonded compartments formed in the article; and (c) placing the article into an environment whereby the one or more active substances are released from each of the one or more bonded compartments at a rate determined by the positive controlled permeability of each respective bonded region formed by the at least one ultrasonically welded seal.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates an article for containing an active substance, in accordance with an embodiment of the invention;

FIG. 2 illustrates an article for containing two active substances, in accordance with an embodiment of the invention;

FIG. 3 illustrates an article for containing two active substances, in accordance with another embodiment of the invention;

FIG. 4 illustrates a cross section of the article of FIG. 3 about axis 3-3′;

FIG. 5 illustrates a flowchart of an ultrasonic welding process for producing ultrasonically welded seals in an article, in accordance with an embodiment of the invention;

FIG. 6 illustrates a flowchart of a method for producing an article and enclosing an active substance within the article, in accordance with an embodiment of the invention;

FIG. 7A is a photomicrograph of a bonded area between two polymeric membranes formed according to the method of the present invention by ultrasonically bonding using a bonding plate pattern as represented in FIG. 7B;

FIG. 7B illustrates a diagram of a staggered “double line” ultrasonic weld seal bonding pattern corresponding to FIG. 7A;

FIG. 8A is a photomicrograph of a continuous bonded region formed by ultrasonic weld seals obtained using the bonding pattern of FIG. 8B;

FIG. 8B illustrates a diagram of staggered “double dot” ultrasonic weld seal bonding pattern corresponding to FIG. 8A;

FIG. 9A is a photomicrograph of a continuous bonded region formed by ultrasonic weld seals obtained using the bonding pattern of FIG. 9B; and

FIG. 9B illustrates a diagram of continuous “zigzag” ultrasonic weld seal bonding pattern corresponding to FIG. 9A.

Additionally, Table 1 provides as cross reference of all figure captions to the above figures and items illustrated within each figure.

### DETAILED DESCRIPTION

The use of the terms “a,” “an,” “the,” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

The term “substance” is used to denote any chemical or physical substance, including substances in the form of liquids, solids, gases and/or vapors.

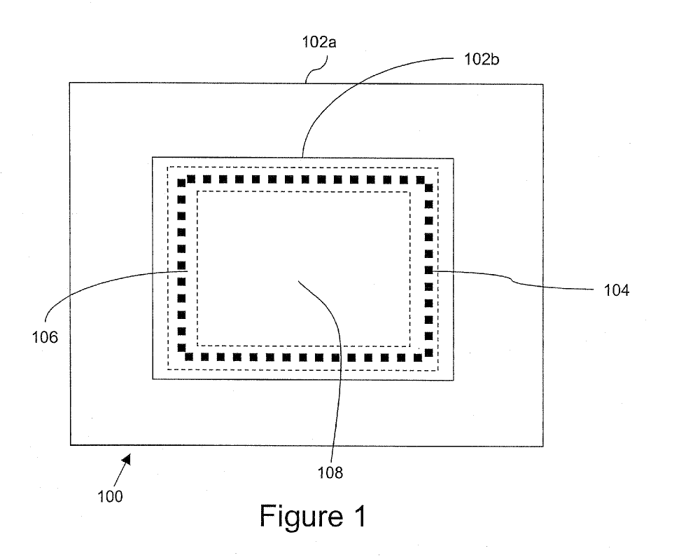

FIG. 1 illustrates an article 100, in accordance with an embodiment of the present invention. Article 100 is used for containing and controllably releasing an active substance (the active substance is not shown in FIG. 1). In other embodiments of the invention, article 100 may be used for containing non-active and non-releasing substances.

FIG. 1 shows article 100 as a pouch-like structure. In other embodiments of the invention, article 100 may have other shapes and structures. Examples of other shapes of article 100 include, but are not limited to, a sheet, an envelop, a sachet, a cylinder, a conical shape, and a box.

Further, article 100 may feature one or more polymeric membranes. In this embodiment of the invention, article 100 is made from a first polymeric membrane 102a and a second polymeric membrane 102b. Parts of the first polymeric membrane 102a and the second polymeric membrane 102b are bonded together using an ultrasonic welding process to produce an ultrasonic welded seal 104. The ultrasonic welding process is well known in the art and is used for producing ultrasonically welded seals between two or more polymeric membranes. Ultrasonic welded seal 104 includes a continuous bonded region 106 formed by the improved ultrasonic welding process of the present invention. Continuous bonded region 106 defines a boundary for a bonded compartment 108. Bonded compartment 108 provides an enclosed interior volume for containing the active substance. Ultrasonic welded seal 104 has a positive controlled permeability for the active substance and the movement of the active substance across ultrasonic welded seal 104 defines a controlled permeation of the active substance from an interior region of the article to an exterior environment in which article 100 is placed. To achieve the controlled permeation, in an embodiment of the present invention, ultrasonic welded seal 104 of article 100 features a plurality of tortuous free paths (the tortuous free paths are not shown in FIG. 1). The plurality of tortuous free paths is an incompletely solid ultrasonically weld region with a plurality of void spaces. The plurality of tortuous free paths is generated by creating a bonding pattern between first polymeric membrane 102a and second polymeric membrane 102b. Different kinds of bonding patterns may be possible according to the present invention in creating a plurality of tortuous free paths in an ultrasonically welded region between one or more polymeric membranes. However, preferred examples of bonding patterns include dotted, broken single lines, broken double lines, zigzag, and blocks. The plurality of void areas in the bonding patterns provides a continuous connected path for a restricted but non-interrupted movement of the active substance across the plurality of tortuous free paths from a bonded compartment to the environment outside of the articles of the present invention.

The plurality of tortuous free paths are present within continuous bonded region 106 of ultrasonic welded seal 104, between first polymeric membrane 102a and second polymeric membrane 102b. The plurality of tortuous free paths controls the direction of movement and diffusion rate of the active substance across ultrasonic welded seal 104. The length and the size of the plurality of tortuous free paths in ultrasonic welded seal 104 determine the overall permeability and diffusion properties of article 100 with respect to the substance contained in bonded compartment 108.

In various embodiments of the present invention, ultrasonic welded seal 104 has a positive controlled permeability for the active substance in the range of about 0.033 bubble-inch per second to less than about 3.33 bubble-inch per second, when measured by Bubble Test Method. The Bubble Test Method may be suitably employed for quantifying the permeability of a membrane and a bonded seal comprising a permeable article. The procedure for carrying out the Bubble Test has been provided later in the ‘Tests and Examples’ section of the detailed description section.

In the given embodiment of the present invention, first polymeric membrane 102a and second polymeric second membrane 102b feature at least one polymeric material selected from the group consisting of polyethylene terephthalate (PET), polyamide, polyurethane (PU), polyester (PES), polyethylene (PE), polyvinyl chloride (PVC), chlorinated polyvinylidene chloride (CPVC), polyacrylamide (PAM), polystyrene (PS), polypropylene (PP), polycarbonate (PC), polyaryletherketone (PEK), poly(cyclohexylene dimethylene cyclohexanedicarboxylate), poly(cyclohexylene dimethylene terephthalate), poly(cyclohexylene dimethylene terephthalate) glycol, polyetherimide, polyethersulfone, poly(ethylene terephthalate) glycol, polyketone (PKO), poly(oxymethylene), polyformaldehyde, poly(phenylene ether), poly(phenylene sulfide), poly(phenylene sulfone), polysulfone, polytetrafluoroethylene (PTFE), poly(vinylidene fluoride), polyamide thermoplastic elastomer, polybutylene, polybutylene terephthalate, polypropylene terephthalate, polyethylene naphthalate (PEN), polyhydroxyalkanoate, polyacrylate (PAA), poly(methyl)methacrylate (PMMA), polytrimethylene terephthalate, polyvinylidene chloride, Tyvek™ and combinations thereof, and copolymeric materials polymerized from of one or more monomers selected from acrylate, acrylonitrile, butadiene, ethylene, formaldehyde, maleic anhydride, melamine, methacrylate, methyl methacrylate, phenol, propylene, styrene, urethane, and vinyl acetate.

In another embodiment of the present invention, polymeric membrane materials can alternatively be formed of thermoplastic elastomers. Examples of the thermoplastic elastomers include, but are not limited to, copolyester thermoplastic elastomer (TPC), olefinic thermoplastic elastomer (TPO), styrenic thermoplastic elastomer (TPS), urethane thermoplastic elastomer (TPU), thermoplastic rubber vulcanisate (TPV), rubber, neoprene, vinyl, silicone elastomer, and combinations thereof. In one embodiment of the invention, any one or combination of the polymeric materials in the form of a non-permeable (solid) polymeric sheet may be employed. In this particular embodiment, first polymeric membrane 102a and second polymeric second membrane 102b are non-permeable to the active substance, such that the overall permeation of the active substance with respect to the formed article 100 is a single mode diffusion rate solely determined by the permeability characteristics of the inventive ultrasonic weld seal formed by ultrasonic bonding of the first and second polymeric membranes.

In another embodiment of the invention, any one or combination of the polymeric materials in the form of one or more non-woven permeable polymeric membranes having effective pore sizes in the range of about 0.01 micrometers to about 100 micrometers can be used for manufacturing first polymeric membrane 102a and second polymeric second membrane 102b. In the given embodiment of the present invention, first polymeric membrane 102a and second polymeric second membrane 102b having effective pore sizes in the range of from about 0.01 micrometers to about 100 micrometers are preferred. In one embodiment, first polymeric membrane 102a and second polymeric second membrane 102b are both permeable to the active substance. Accordingly, in this embodiment, the overall permeability of the active substance with respect to the formed article 100 is a superposition of the permeability of the active substance with respect to the permeable membrane 102a and 102b and the permeability of the active substance with respect to the characteristics of the inventive ultrasonic weld seal formed by ultrasonic bonding of the first and second polymeric membranes. Thus, in this embodiment, a multimodal diffusion profile, by the superposition of permeability characteristics exhibited by first polymeric membrane 102a, second polymeric membrane 102b and ultrasonic welded seal 104 is manifested by the article with respect to the active substance contained with the bonded compartment 108 of article 100.

In other embodiments of the invention, an article may include polymeric membranes with uniform or non-uniform pore size in the desired range, to achieve a desired effect on the overall diffusion profile, represented by the superposition of permeability characteristics of the formed article 100 with respect to the active substance.

In other embodiments of the invention, an article may include polymeric membranes with selective permeability characteristics with respect to one or more substances contained within the bonded compartment such that permeation of the one or more substances from bonded compartment 108 to an exterior environment is controlled by the permeability characteristics of the respective polymeric membrane that provides permeability to one or more active substances. An example of this embodiment is an article 100 containing an active substance A and an active substance B wherein polymeric membrane 102a provides permeability to substance A only, polymeric membrane 102b provides permeability to substance B only, and ultrasonic weld seal 104 provides controlled permeability to substance A and B, resulting in an overall multimodal diffusion profile with respect to substances A and B that can be selectively determined by selection of the two polymeric membranes 102a and 102b and the characteristics of the ultrasonic weld seal 104 according to the methods of the present invention.

In other embodiments of the invention, one or both of first polymeric membrane 102a and second polymeric membrane 102b may be selected to have permeability with respect to an external substance not contained within article 100, while simultaneously being non-permeable with respect to an active substance contained within bonded compartment 108 within article 100. A non-limiting example is an article formed with a first water permeable membrane 102a and a non-water permeable membrane 102b that is placed into an aqueous environment during use, having characteristics that then enable water from the surrounding aqueous environment to diffuse into the bonded compartment 108 to activate the active substance to generate a reactive product within the bonded compartment that is released from the article at a controlled diffusion rate determined by the permeability characteristics of the ultrasonic welded seal 104 of the article.

One of the applications of article 100 is achieving desired movement of the active substance, both in terms of direction and diffusion rate, across ultrasonic welded seal 104. The controlled permeation of the active substance across ultrasonic welded seal 104 allows an accurate quantity of the active substance to be contained in article 100 and delivered with efficacy to the point of use of the article.

In various embodiments of the present invention, the active substance can be in the form of a gas, a saturated vapor, a liquid, a solid, a particulate and a solution. The active substance is selectively chosen to provide a controlled positive permeability across ultrasonic welded seal 104, with respect to at least one of a gas, saturated vapor, a liquid and a solution. The movement of the active substance across ultrasonic welded seal 104 can be activated by environmental factors, physical factors, chemical factors, thermal factors or any combinations thereof.

In various embodiments of the present invention, applications of the article include, but are not limited to, a vapor releasing article, an odor or liquid absorbing article, a liquid releasing pouch, a solid containing pouch that reacts with environmental water or water vapor to produce one or more of a gas, a liquid, a solution that permeates outward across an ultrasonically welded seal of the article. In various such embodiments, the article containing an active substance, is stored and transported in a non-permeable outer pouch, so that the article does not allow any release of the active substance until the outer pouch is removed. Further, the non-permeable outer pouch protects the article from any environmental and chemical changes. In various embodiments, an environmentally degradable coating on the exterior surface of the article is employed so that the article does not allow any release of the active substance until the outer environmentally degradable coating is removed. One non-limiting example is a coating of a water-soluble coating that is non-permeable with respect to the active substance contained within the article, but which dissolves when the article is placed into an aqueous environment and thus is effectively removed from the surface of the article at the point of use.

Examples of the active substances contained inside the article may include, but are not limited to, air-treating materials. Examples of the air-treatment substances include chlorine dioxide, vaporized hydrogen peroxide, and vaporized hypochlorous acid, which can be released into a room, an interior space of a car, a tumble dryer, or a fabric treatment device. The active substances may be selected to either produce a second active substance for release upon some appropriate trigger event at point of use, such as exposure to heat or water, for example, or alternatively two or more substances may be combined which generate an active substance in situ within the article upon an appropriate trigger event, so that the active substance is released at point of use. Further, the article may include fluid-treating compositions that release active substances such as a liquid solution, a gel, a powder, or a suspended powder in aqueous or non-aqueous medium. These fluid-treating compositions may be used for treating laundry, or hard surfaces, for example, and may include, but are not limited to, bleaches, oxidants, surfactants, solvents, fragrances, disinfectants, and combinations thereof. When the article containing the fluid-treating compositions is squeezed, pressurized, used as wiping article, or placed into water, such as into a water filled bucket or a washing machine, or is submerged in an aqueous or non-aqueous liquid media, the fluid-treating compositions are released into the surrounding medium to produce a treatment composition appropriate for a particular use.

According to the embodiment depicted in FIG. 1, ultrasonic welded seal 104 includes continuous bonded region 106 with a uniform positive controlled permeability for the active substance. In this embodiment, the movement of the active substance across ultrasonic welded seal 104, used to weld first polymeric membrane 102a and second polymeric second membrane 102b, defines a single mode permeability with respect to the active substance resulting in a single mode diffusion rate of the active substance from the article to a surrounding environment. The single mode permeation allows a single path of permeation of the active substance between the inside and outside of article 100 at a predefined controlled rate, the permeation being controlled completely by the characteristics of ultrasonic welded seal 104.

In other embodiments of the invention, an article may feature at least one ultrasonically welded seal with a positive controlled permeability for an active substance. Further, the article may additionally include other bonded seals, wherein the other bonded seals may be non-permeable. The non-permeable bonded seals may or may not be bonded using an ultrasonic welding process. Where a non-permeable bonded seal is to be formed in an article of the present invention, any bonding process known to those in the art may suitably be employed to form such non-permeable bond.

In another embodiment of the invention, the article may feature a plurality of polymeric membranes. The plurality of polymeric membranes are welded together by a plurality of the ultrasonically welded seals to form a bonded region. The bonded region defines a bonded compartment for containing an active substance. Further, the plurality of the ultrasonically welded seals have different positive controlled permeability's for the active substance. This allows the article to exhibit a multiple mode permeation of the active substance. A first kind of the multiple mode permeation may be achieved when at least two of the plurality of the ultrasonically welded seals have different positive controlled permeability's for the active substance. The multiple mode permeation of the active substance allows a simultaneous movement of the active substances through two or more different paths at the same or different diffusion rates. The direction of the movement of the active substances may also vary for the different paths. For example, when a vapor releasing active substance is contained in a pouch, the vapor releasing active substance is able to chemically react with moisture around the pouch and releases the desired vapor. In a first step, the moisture surrounding the exterior of the pouch permeates inside the article through a first path. In a second step, a chemical reaction takes place between the moisture and vapor releasing active substance, and in a third step the vapor of the vapor releasing active substance permeates through a second path outward from the bonded compartment of the pouch to the exterior of the pouch, diffusing in a fourth step into the immediately surrounding environment.

In yet another embodiment of the present invention, the article features one type of polymeric membrane with a selected membrane permeability for the active substance. The article further features at least one ultrasonically welded seal having a positive controlled permeability for the active substance. In this embodiment, the movement of the active substance across the at least one ultrasonically welded seal and across the one type of polymeric membranes provide a second kind of mechanism for multiple mode permeation of the active substance, wherein the selected membrane permeability of the one polymeric membrane and the positive controlled permeability of the at least one ultrasonically welded seal are set at predefined diffusion rates. The permeation characteristics of the ultrasonically welded seal and the polymeric membrane can be same or different from each other to produce a single mode or dual mode diffusion rate of the active substance.

In another embodiment of the invention, the article may feature at least two polymeric membranes having different selected membrane permeability's for the active substance, and an ultrasonically welded seal having a positive controlled permeability for the active substance. In this embodiment, the movement of the active substance across the ultrasonically welded seal and across the at least two of the polymeric membranes provide a third kind of mechanism for multiple mode diffusion rates of the active substance.

In various other embodiments of the present invention, the polymeric membranes may be non-permeable in nature or treated, by any means known in the art, to exhibit a selected membrane permeability, or an adjustable membrane permeability that varies with respect to an external parameter such as for example, surrounding media temperature, electrolyte strength, solvent polarity, osmotic pressure, pH, alkalinity, and combinations thereof. One may select a non-permeable membrane, or any combination of non-permeable and permeable membranes, or alternatively any one or more combination of the permeable membranes to construct an article of the present invention. By selecting the appropriate membrane material, whether being non-permeable or exhibiting the selected membrane permeability, the article of the present invention can be constructed by employing an ultrasonically welded seal that exhibits either single mode permeation or multiple mode permeation characteristics with respect to one or more active substances contained within one or more bonded regions of the article.

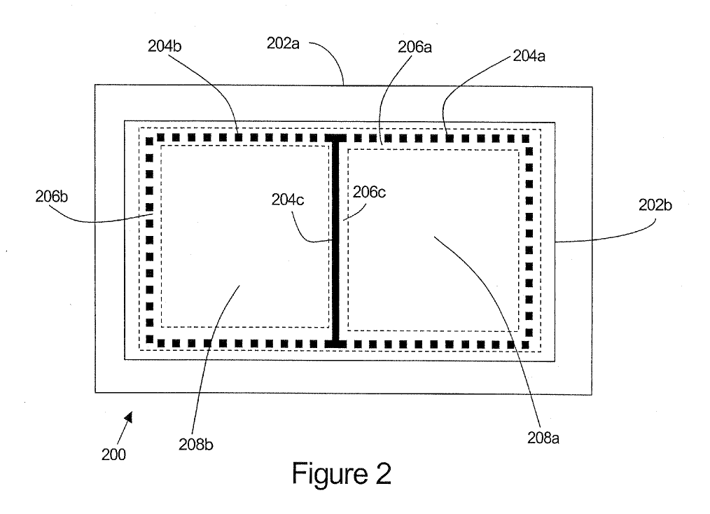

FIG. 2 illustrates another embodiment of the present invention. FIG. 2 illustrates an article 200 for containing and controllably releasing two active substances. Article 200 features a third polymeric membrane 202a and a fourth polymeric membrane 202b. Third polymeric membrane 202a and fourth polymeric membrane 202b are bonded using the ultrasonic welding process of the present invention to produce a first ultrasonically welded seal 204a, a second ultrasonically welded seal 204b and, by means of a conventional ultrasonic welding process, an adjacent ultrasonically welded seal 204c. First ultrasonically welded seal 204a forms a first non-adjacent bonded region 206a, second ultrasonically welded seal 204b forms a second non-adjacent bonded region 206b, and adjacent ultrasonically welded seal 204c forms an adjacent bonded region 206c. In other embodiments of the present invention, adjacent bonded region 206c can be formed by any kind of welding process. First non-adjacent bonded region 206a and adjacent bonded region 206c define a first bonded compartment 208a. Second non-adjacent bonded region 206b and adjacent bonded region 206c define a second bonded compartment 208b. In this embodiment, first bonded compartment 208a and second bonded compartment 208b contain two different active substances A and B (active substances A and B are not shown in figure), respectively. Adjacent bonded region 206c is shared by first bonded compartment 208a and by second bonded compartment 208b. Adjacent ultrasonically welded seal 204c is non-permeable with respect to the active substances A and B contained within first bonded compartment 208a and second bonded compartment 208b, respectively. First ultrasonically welded seal 204a and second ultrasonically welded seal 204b each have a positive controlled permeability with respect to the active substances A and B contained within first bonded compartment 208a and second bonded compartment 208b, respectively. Third polymeric membrane 202a and fourth polymeric membrane 202b of article 200 are non-permeable with respect to active substances A and B, respectively. Article 200 allows the controlled permeation of the active substances A and B through first non-adjacent bonded region 206a and second non-adjacent bonded region 206b, respectively. First non-adjacent bonded region 206a and second non-adjacent bonded region 206b have uniform but different positive controlled permeability's. The positive controlled permeability's of first ultrasonically welded seal 204a and second ultrasonically welded seal 204b are dependent on the tortuous free paths created between third polymeric membrane 202a and fourth polymeric membrane 202b produced by the inventive ultrasonic welding process. In this embodiment, article 200 has application in releasing two active substances A and B simultaneously into a surrounding environment. In other embodiments, either a product occurring from the reaction between the active substances A and B, or a mixture of the active substances A and B, when released in the environment, produces a desired effect. The controlled release of the active substances A and B across first ultrasonically welded seal 204a and second ultrasonically welded seal 204b, respectively, provide the single mode of permeation for the active substances A and B, each active substance diffusing in a single mode rate with respect to the permeability of the respective ultrasonic welded seal defining the bonded region of the respective bonded compartment containing the respective active substance. In related embodiments, the controlled permeability of the respective ultrasonic welded seals controlling the release of the two active substances A and B can be adjusted to allow diffusion rates such that the rate of diffusion of one active substance is significant greater than the other, or can be adjusted to provide substantially equivalent diffusion rates with respect to one active, so that active substance A and B are released into the surrounding environment at a similar rate.

In a variation of the above embodiment, the two actives substances A and B can be contained in an article comprising two polymeric membranes that define two bonded compartments. The two bonded compartments are defined by two non-adjacent ultrasonically welded seals and a common adjacent ultrasonically welded seal at the junction of the two bonded compartments. The adjacent ultrasonically welded seal is non-permeable. The two non-adjacent ultrasonically welded seals of the bonded compartments have a positive controlled permeability and at least one of the two polymeric membranes of the article has a selected membrane permeability. The movement of the active substances A and B across the non-adjacent ultrasonically welded seals and the polymeric membranes define a multi modal controlled permeation of the active substances A and B.

In another embodiment of the present invention, one or more polymeric membranes are ultrasonically bonded to form one or more continuous bonded regions that provide a plurality of bonded compartments for containing one or more active substances. The plurality of bonded compartments selectively contains the one or more active substances individually, or in any desired combination, and, optionally, further contains one or more non-active substances, such as for example a fluid carrier, solvent, water or the like. The one or more polymeric membranes can be optionally permeable to the one or more active substances. The at least one ultrasonically welded seal shared between two or more adjacent bonded compartments forms an adjacent bonded region, the adjacent bonded region being non-permeable with respect to the one or more active substances contained within the two or more adjacent bonded compartments. Further, the non-adjacent bonded regions of the plurality of bonded compartments feature the ultrasonically welded seals having positive controlled permeability with respect to the one or more active substances.

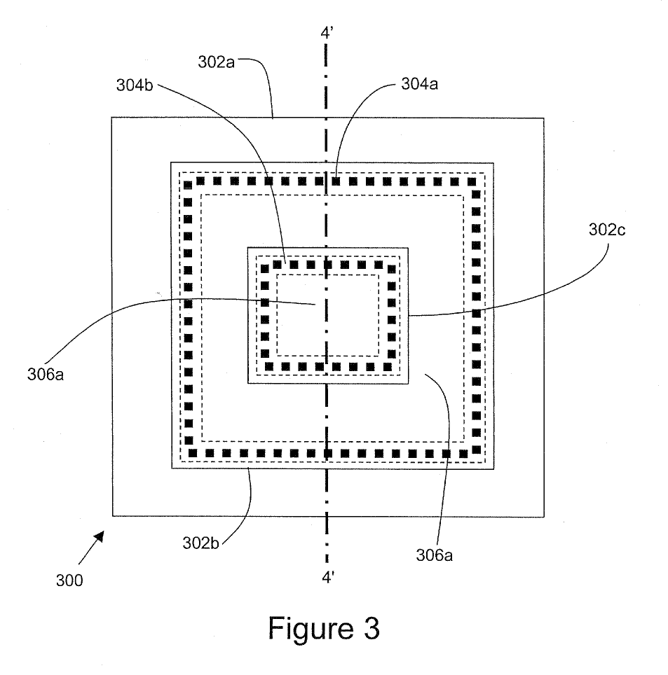

FIG. 3 illustrates an article 300, in accordance with another embodiment of the present invention. Article 300 contains and controllably releases two active substances. Article 300 features a fifth polymeric membrane 302a, a sixth polymeric membrane 302b and a seventh polymeric membrane 302c. Fifth polymeric membrane 302a and sixth polymeric membrane 302b are bonded using the ultrasonic welding process and produce a first ultrasonically welded seal 304a. Sixth polymeric membrane 302b and seventh polymeric membrane 302c are bonded using the ultrasonic welding process and produce a second ultrasonically welded seal 304b. Fifth polymeric membrane 302a and sixth polymeric membrane 302b are bonded to define a third bonded compartment 306a. Sixth polymeric membrane 302b and seventh polymeric membrane 302c are bonded to define a fourth bonded compartment 306b. Active substances contained within the third and fourth bonded compartments are not shown in FIG. 3.

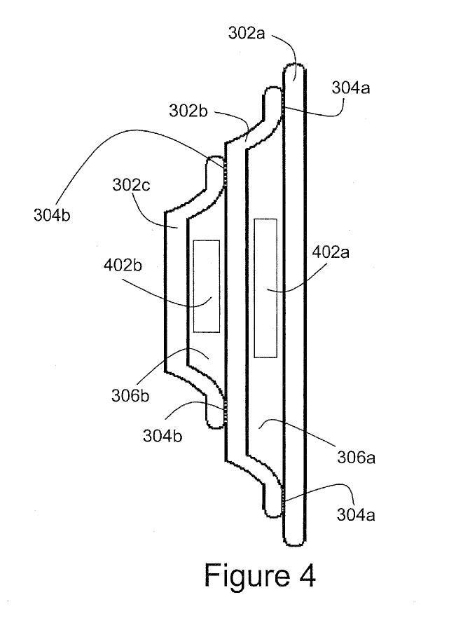

FIG. 4 illustrates a sectional view of article 300 along the axis 3-3′ shown in FIG. 3. FIG. 4 illustrates third bonded compartment 306a and fourth bonded compartment 306b in more detail. In this embodiment of the present invention, third bonded compartment 306a and fourth bonded compartment 306b of article 300 contain a first active substance 402a and a second active substance 402b, respectively. Article 300 allows the movement of the active substances 402a and 402b across third ultrasonically welded seal 304a and fourth ultrasonically welded seal 304b, respectively. In this embodiment, fifth polymeric membrane 302b, sixth polymeric membrane 302b and seventh polymeric membrane 302c are non-permeable with respect active substances 402a and 402b. In other embodiments of the present invention, fifth polymeric membrane 302a and seventh polymeric membrane 302c of article 300 are optionally permeable with respect to active substances 402a and 402b, respectively, and sixth polymeric membrane 302b of article 300 is non-permeable with respect to active substances 402a and 402b. In this embodiment, active substances 402a and 402b may independently be present in any suitable form, including but not limited to, a gas, vapor, liquid, solid, powder, particulate, solution of an active in a liquid carrier medium, and combinations thereof.

In another embodiment of the invention, one or more polymeric membranes of an article are ultrasonically bonded to form one or more continuous bonded regions. The one or more continuous bonded regions define a plurality of bonded compartments for containing one or more active substances. The plurality of bonded compartments selectively contains the one or more active substances individually, or in any desired combination. The polymeric membranes shared between any two adjacent bonded compartments are non-permeable with respect to the active substances contained in the adjacent bonded compartments. In this embodiment, a combination of the active substances released in the environment produce a desired effect.

In yet another embodiment of the present invention, the ultrasonic welding process is used to produce an article with an inner bonded compartment enclosed within an outer bonded compartment. The inner bonded compartment contains a first active substance, and the outer bonded compartment contains a second active substance. Further, ultrasonically welded seals forming the inner and outer bonded compartments have positive controlled permeability's with respect to the first and second active substances. In this embodiment, release of the first active substance occurs into the outer bonded compartment, enabling the first active substance and the second active substance to react and produce a third active substance, which is controllably released from the outer bonded compartment to the surrounding environment.

In other variations of this embodiment, an inner bonded compartment with a permeable ultrasonically welded seal is enclosed within an outer bonded compartment defined by a non-permeable seal with a tear perforation. The outer bonded compartment contains a first active substance and the inner bonded compartment contains a second active substance. The inner bonded compartment shares an ultrasonically welded seal with the outer bonded compartment, the ultrasonically welded seal of the inner bonded compartment having a controlled permeability for the second active substance. The outer bonded compartment can be opened by user to release the first active substance contained in it. The first active substance reacts with the environment and is capable of controlling the permeability of the second active substance present in the inner bonded compartment through the ultrasonically welded seal.

In an embodiment of the present invention, release of one or more active substances contained within an article across the ultrasonically welded seals is achieved, by use of the article on a hard surface, wherein the one or more active substances are released due to applied pressure. In another embodiment, the release of the one or more active substances is achieved by applied heat. In yet another embodiment, water is diffused into the article and the water reacts with the one or more active substance to cause a gaseous release of the active substances out of the article. In another embodiment of the present invention, the article is submerged in water, the release of the one or more active substance being achieved by hydrostatic pressure. In yet another embodiment, the article is submerged in water, water diffuses into the article, and the active substance is released into the water by permeation.

In an embodiment of the present invention, an ultrasonic weld station is used to form an article for containing and controllably releasing an active substance. The article includes one or more polymeric membranes for forming one or more bonded regions, the one or more bonded regions defining at least one bonded compartment, the at least one bonded compartment providing an enclosed interior volume for containing the active substance. In the present embodiment, parts of the one or more polymeric membranes are bonded together to obtain an ultrasonically welded seal. The ultrasonically welded seal provides a positive controlled permeability for the active substance. The desired selected permeability characteristics of the article are achieved by selecting suitable process parameters of the ultrasonic weld station. The suitable process parameters include a bonding pattern, weld energy, energy density, duration of welding and weld speed. The operation of creating the ultrasonically welded seal between the one or more polymeric membranes encompasses the creation of a plurality of tortuous free paths between the one or more polymeric membranes, the plurality of tortuous free paths allowing movement of the active substance across the ultrasonically welded seal in a controlled manner. Further, the ultrasonic weld station may produce the ultrasonically welded seals with a uniform positive permeability or a non-uniform positive permeability determined by the bonding pattern of the plurality of tortuous free paths in the ultrasonically welded seals.

### Formation of Ultrasonically Welded Seal

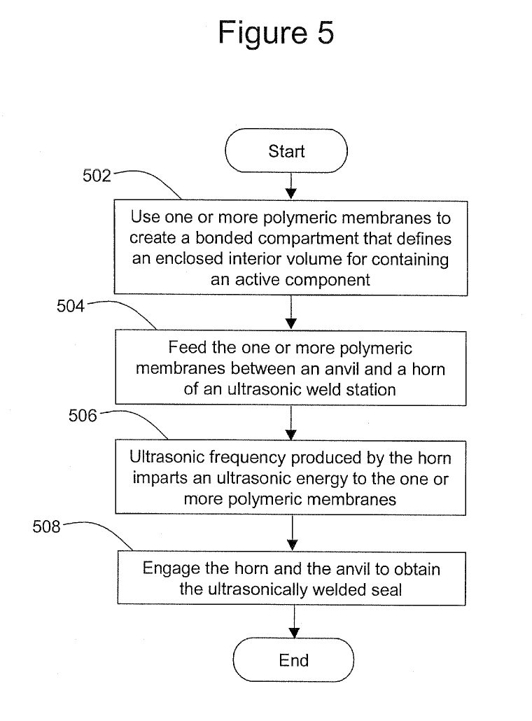

FIG. 5 is a flowchart of one method for forming an ultrasonically welded seal, in accordance with an embodiment of the invention. At operation 502, one or more polymeric membranes are used to define an enclosed interior volume for containing an active substance. At operation 504, the one or more polymeric membranes are fed between an anvil and a horn of an ultrasonic weld station. The feeding speed is in the range of from about 2 feet per minute to about 10 feet per minute. The gap between the horn and the anvil is in the range of from about 0.01 millimeter to about 0.15 millimeter. At operation 506, the horn produces an ultrasonic frequency that imparts an ultrasonic energy to the one or more polymeric membranes. At operation 508, the horn and the anvil are engaged to obtain the ultrasonically welded seal that bonds a part of the one or more polymeric membranes, wherein the ultrasonically welded seal defines a bonded compartment formed using the one or more polymeric membranes. The pressure applied by the anvil to the horn is in the range of about 10 pounds per square inch per square inch gauge to about 100 pounds per square inch per square inch gauge. In the above embodiment, the ultrasonically welded seal have a positive controlled permeability for the active substance. The positive permeability of the ultrasonically welded seal is controlled by controlling the process parameters which involve the weld energy, the energy density, the duration of welding and the weld speed.

In one embodiment, an ultrasonically welded seal is formed between two polymeric membranes by welding them between the mating surfaces of a horn and anvil, which may individually bear engraved, embossed or planar surface features that act in concert when brought into convergence with the polymeric membranes to form the desired bonding pattern. The bonding pattern is transferred to the polymeric membranes when the horn and anvil are engaged with the polymeric membranes between them so that their convergence forms a weld pattern that corresponds to the desired bonding pattern during an ultrasonic welding operation. The bonding pattern formed in the polymeric membranes consists of one or more ultrasonic weld seals across the bonded region where the polymeric membranes are welded. In one embodiment, a continuous ultrasonic weld seal that is contiguous across the bonded region is formed. In another embodiment, a discontinuous series of individual ultrasonic weld seals are formed that are not contiguous across the area of the bonded region. In this latter embodiment, the ultrasonic weld seals define a pattern of bonded areas and non-bonded areas within the bonded region to form a permeable interstitial bonded region featuring a plurality of tortuous paths formed by the non-bonded region being the interstitial area between the one or more bonded regions. The interstitial bonded region forms multiple tortuous paths within the interior region of the bonding area that are continuous from one side (an exterior side) of the bonded region to a second side (an anterior side) of the bonded region. During a welding operation, the polymeric membranes may be translated perpendicularly to the horn and anvil with a second welding operation so that a second bonded region immediately adjacent to the first bonded region is formed. This process can be repeated a multiple number of times to produce a series of ultrasonically welded seals defining a series of adjacent bonded regions forming a continuous pattern of bonded regions. Adjacent bonded regions may overlap so that the repeating bonding pattern forms a continuous ultrasonically welded seal across an area of the polymeric membranes.

In another embodiment, the desired bonding pattern, used to create a plurality of tortuous paths in the ultrasonically welded seal, can be formed by surface features present on either the anvil, or horn or both, such that the engagement of the horn and the anvil causes formation of a desired plurality of tortuous paths between welded parts of the polymeric membranes. In one embodiment, the bonding pattern is formed by a raised embossed pattern formed on the surface of the horn while the surface of the anvil is essentially planar. In another embodiment, the bonding pattern is formed by corresponding embossed and engraved patterns formed on the surface of the anvil and/or horn, so that the desired bonding pattern is formed by the convergence of the anvil and horn. In one embodiment, the bonding pattern is formed by the complementary pattern of embossed and engraved portions on either respective mating surface of the horn and anvil so as not to overlap during the welding process to form a series of ultrasonically welded seals in the pattern of multiple circular ultrasonically welded seals resembling “dots” form between the polymeric membranes. In other embodiments, the bonding pattern may take the form of a repeating series of geometric shaped areas, including circular, oval, triangular, rectangular, trapezoidal, square, fractal, polygonal and irregular areas, and combinations thereof. In an embodiment, subsequent adjacent bonding regions overlap to some extent within at least one adjacent bonding region or meet the adjacent bonding region on at least one common side of the two bonding regions so as to form a continuous bonding region between the two adjacent weld sites. In another embodiment, a multiple series of adjacent bonding regions define a continuous series of bonding areas in the form of discrete, repeating geometric shaped areas that extend across the polymeric membrane to form a continuous ultrasonic weld seal that features a series of non-contiguous bonded regions which define a permeable interstitial bonded region within the continuous repeating ultrasonically welded seal. In these embodiments, a continuous bonded region is formed between the polymeric membranes that extends in at least one direction with a dimensional size greater than a single bonded region defined by the size of the horn and anvil mating surface area.

In another embodiment, a rolling horn and anvil assembly may be employed where the bonding pattern to be formed is embossed on the mating surface on either or both the horn and anvil assembly so that upon translation of the assembly with respect to the two polymeric membranes positioned between the mating surfaces, a continuous ultrasonically welded seal is produced. In an alternate embodiment, an embossed bonding pattern is present on the surface of the horn in the shape of a spherocylindrical roller that bears the bonding pattern in a rotationally symmetrically loop configuration so that the bonding pattern defining the bonded region is formed upon one complete 360 degree rotation of the rolling horn perpendicular to the spherocylindrical axis of the anvil. In this present embodiment, a continuous or repeating contiguous bonded region may be formed between the two polymeric membranes in an uninterrupted ultrasonic bonding process during which the two membranes are translated in continuous step with the rotation of the rolling horn in the region between the mating surfaces of the anvil and horn. In one embodiment, the horn and anvil are both freely rotating spherocylindrical members whose mating surfaces can be brought into close proximity to each other and about the two polymeric membranes so as to facilitate forming of a continuous or repeating bonded region by feeding the membranes between them during a welding operation in which ultrasonic energy is fed to the horn member. In another embodiment, the anvil is an essentially planar surface supporting the two polymeric membranes for engagement with a rolling horn assembly that is translated in a direction perpendicular to the stationary membranes supported by the stationary anvil so as to form a continuous or contiguous bonding region during a welding process.

In another embodiment, an article may be formed where all ultrasonic weld seals are formed simultaneously across at least one continuous face of at least one polymeric membrane by employing an anvil and horn assembly with a bonding pattern that is sized appropriately to a corresponding size that encompasses all bonded regions of the formed article, so that formation of multiple ultrasonically welded seals defining a complete bonding region defining a completed sealed article is completed by application of a single welding operation upon that article.

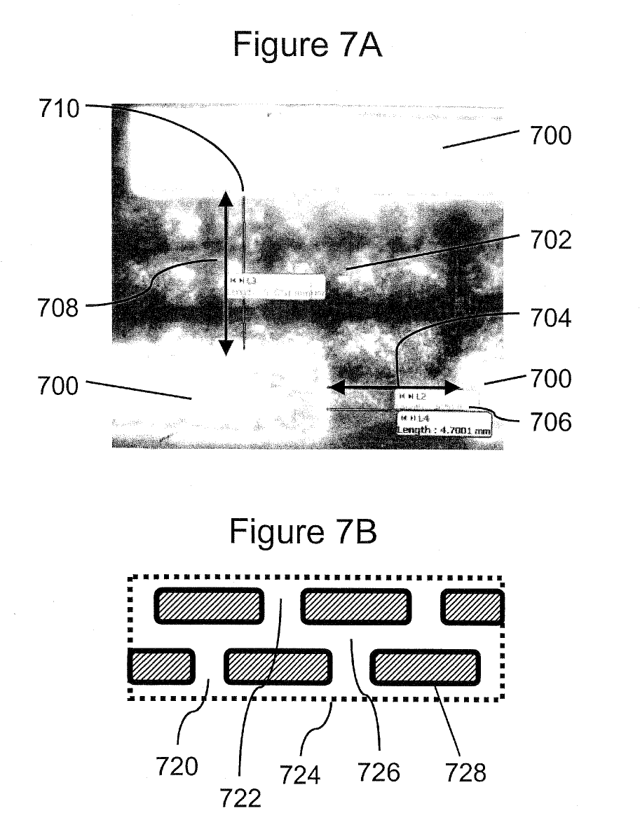

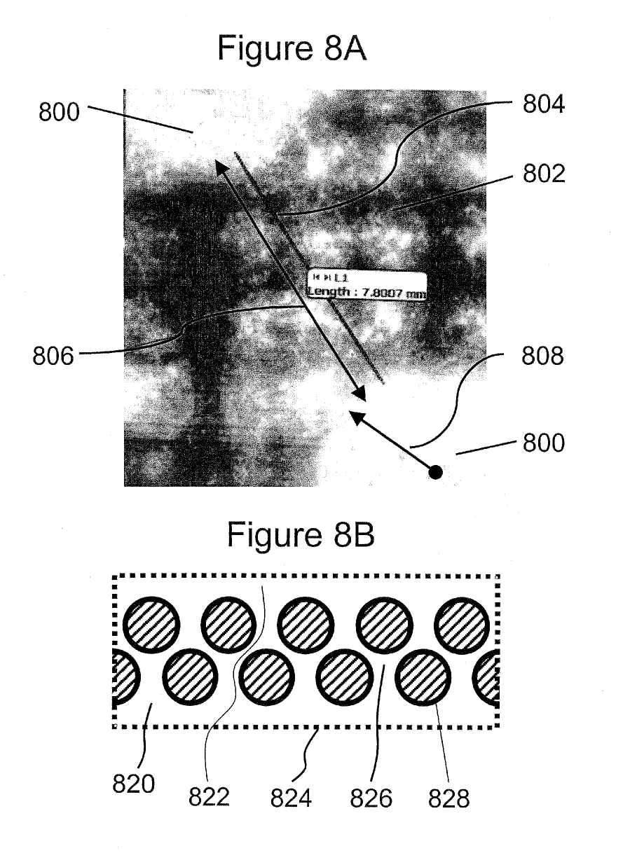

FIGS. 7A and 7B illustrate one embodiment of the present invention where a continuous bonded region between two polymeric membranes is formed by ultrasonic weld seals obtained using a staggered “double line” ultrasonic weld seal bonding pattern. FIG. 7A illustrates a photomicrograph taken of an ultrasonically welded article consisting of two polymeric membranes being Dupont Tyvek™ HomeWrap® (IPC 8301410243) sheeting obtained from Home Depot. Photomicrographs were taken from a generally top view perpendicular to the plane of the ultrasonically welded seal in the article which was illuminated from the top with a white light source for photographic image capture by a conventional digital camera mounted to a microscope with a 10× optical magnification power image capture stage. Referring to FIGS. 7A and 7B together, a plurality of ultrasonically welded seal 700 is present within a bonded region 724, each ultrasonically welded seal 700 being a bonded area between the two polymeric sheets formed by an ultrasonic welding process. The bonded region 724 features an anterior side of bonded region 720 that communicates with interstitial bonded region 726. The bonded region 724 features an exterior side of bonded region 722 that communicates with interstitial bonded region 726. Within the bonded region 724 is a plurality of ultrasonically welded seal 700 formed by means of a repeating ultrasonic weld seal pattern 728. Together, anterior side of bonded region 720, interstitial bonded region 726 and exterior side of bonded region 722 define a bonded region 724 that is a continuous bonded region with a uniform positive controlled permeability for an active substance.

Within bonded region 724, the repeating ultrasonic weld seal(s) 700 are positioned in an approximately parallel and rectolinear configuration represented by a series of uniformly spaced and offset weld areas formed by each individual weld seal 700 in the pattern illustrated in FIG. 7B. Spacing between each adjacent ultrasonic weld seal 700 along a common parallel and rectolinear direction is represented as parallel separation dimension 704. In this present embodiment, scale bar 710 is 5.38 mm in length corresponding to perpendicular separation dimension 708, while scale bar 706 is 4.70 mm in length corresponding to parallel separation dimension 704. Likewise, approximately identical spacing and offset dimensions are repeated within the bonded region 724. In FIG. 7A, permeable interstitial bonded region 702 corresponds to interstitial bonded region 726. Collectively, the continuous interstitial bonded region 726 formed by adjacent bonded region 724 employed as an ultrasonic welding pattern and extending along a continuous ultrasonic weld seam, formed between two polymeric membranes in construction of an ultrasonically welded article according to the present invention, provides a tortuous path for diffusion and controlled release of an active substance from an anterior side of bonded region 720 to exterior side of bonded region 722 in communication via permeable interstitial bonded region 702. In other embodiments, the geometry of the ultrasonic weld seal 700 formed by the repeating ultrasonic weld seal pattern 728 can be varied in any dimension and shape, such as for example by employing a square shape for weld seal pattern 728. In other embodiments, any polygonal shape can be employed for example, including but not limited to, a rectangle with any selected length and width dimensions, a star having m number of points, a polygon with n number of sides, wherein m and n are represented by a positive non-zero integer, wherein the polygonal shape may have sides of equivalent or non-equivalent dimension, and combinations thereof. In other embodiments, the parallel separation dimension 704 and perpendicular separation dimension 708 can be varied independently to any selected value so that the overall size and dimensions of bonded region 724 can be optimized. Further, the parallel separation dimension 704 and perpendicular separation dimension 708 can be varied independently to any selected value so as to enable production of a welded seam having a smaller or greater extent of void space as represented by permeable interstitial bonded region 702. Alternatively, the parallel separation dimension 704, perpendicular separation dimension 708, and the shape and dimensions of ultrasonic weld seal 700 can be varied independently to any selected value so as to produce permeable interstitial bonded region 702 of the desired permeability as determined by the number and extent of a plurality of tortuous paths created between the anterior side of bonded region 720 and exterior side of bonded region 722 by a plurality of ultrasonic weld seal 700 repeated in a pattern corresponding to bonded region 724. In other embodiments, selection of welds seal geometry, weld seal dimensions, weld seal separations and weld seal patterns can all be independently selected to produce an ultrasonically welded article according to the present invention having any desired void space as represented by permeable interstitial bonded region 702, resulting in an article that exhibits the desired permeability with respect to a selected active substance contained with a bonded compartment of the article where the bonded compartment is sealed by continuous bonded region 724.

The article represented in FIG. 7A was produced employing a gap size of about 0.0025 inches with a translation speed of about 10 f.p.m. and an anvil pressure of about 70 p.s.i.g., with all other parameters constant as described above.

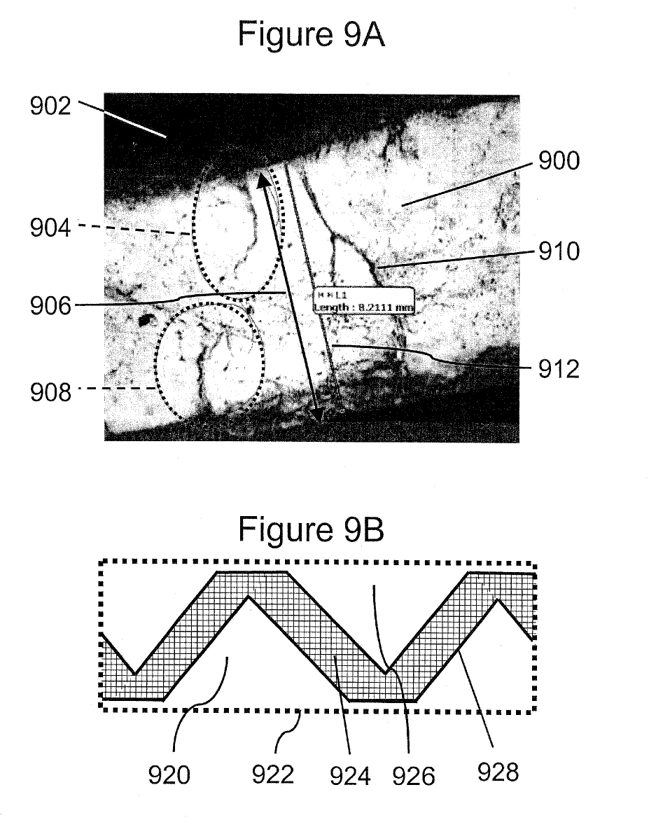

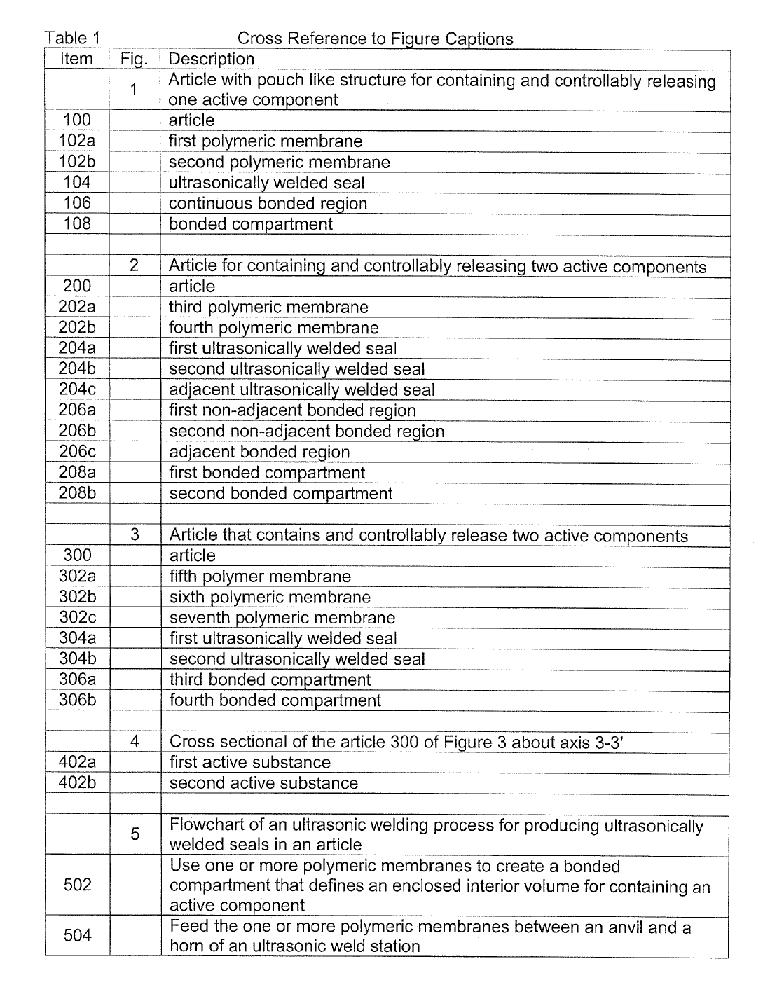

FIGS. 8A and 8B illustrate one embodiment of the present invention where a continuous bonded region between two polymeric membranes is formed by ultrasonic weld seals obtained using a staggered “double dot” ultrasonic weld seal bonding pattern. FIG. 8A illustrates a photomicrograph taken of an ultrasonically welded article consisting of two polymeric membranes of Dupont Tyvek™ HomeWrap® sheeting. Photomicrographs were taken from a generally top view perpendicular to the plane of the ultrasonically welded seal under the same conditions as described in FIG. 7A. Referring to FIGS. 8A and 8B together, a plurality of ultrasonically welded seal 800 is present within a bonded region 824, each ultrasonically welded seal 800 being a bonded area between the two polymeric sheets formed by an ultrasonic welding process. The bonded region 824 features an anterior side of bonded region 820 that communicates with interstitial bonded region 826. The bonded region 824 features an exterior side of bonded region 822 that communicates with interstitial bonded region 826. Within the bonded region 824 is a plurality of ultrasonically welded seal 800 formed by means of a repeating ultrasonic weld seal pattern 828. Together, anterior side of bonded region 820, interstitial bonded region 826 and exterior side of bonded region 822 define a bonded region 824 that is a continuous bonded region with a uniform positive controlled permeability for an active substance.

Within bonded region 824, the repeating ultrasonic weld seal(s) 800 are positioned in an approximately parallel and rectolinear configuration represented by a series of uniformly spaced and offset weld areas formed by each individual weld seal 800 in the pattern illustrated in FIG. 8B. In this embodiment, spacing between each adjacent ultrasonic weld seal 800 along a common parallel and rectolinear direction is approximately equivalent to the interspacing between each adjacent ultrasonic weld seal 800, represented as separation dimension 806. In this present embodiment, scale bar 804 is 7.80 mm in length corresponding to a separation dimension 806 between the generally circularly shaped dots corresponding to a plurality of ultrasonic weld seal 800. In this embodiment, ultrasonic weld seal 800 are uniformly spaced with respect to each adjacent weld seal in the pattern, each ultrasonic weld seal 800 being generally circular in shape and having radius dimension 808, which is equivalent to 3.25 mm.

In FIG. 8A, permeable interstitial bonded region 802 corresponds to interstitial bonded region 826. Collectively, the continuous interstitial bonded region 826 formed by adjacent bonded region 824 employed as an ultrasonic welding pattern and extending along a continuous ultrasonic weld seam, formed between two polymeric membranes in construction of an ultrasonically welded article according to the present invention, provides a tortuous path for diffusion and controlled release of an active substance from an anterior side of bonded region 820 to exterior side of bonded region 822 in communication via permeable interstitial bonded region 802. In other embodiments, the shape and geometry of the ultrasonic weld seal can be selected to be an desired size, geometry and dimension. Example geometries include, but are not limited to, points, circles, ellipses, ovals, tear-drops and free-form curvilinear shapes defining a closed area of any selected size and dimension, as well as combinations thereof.

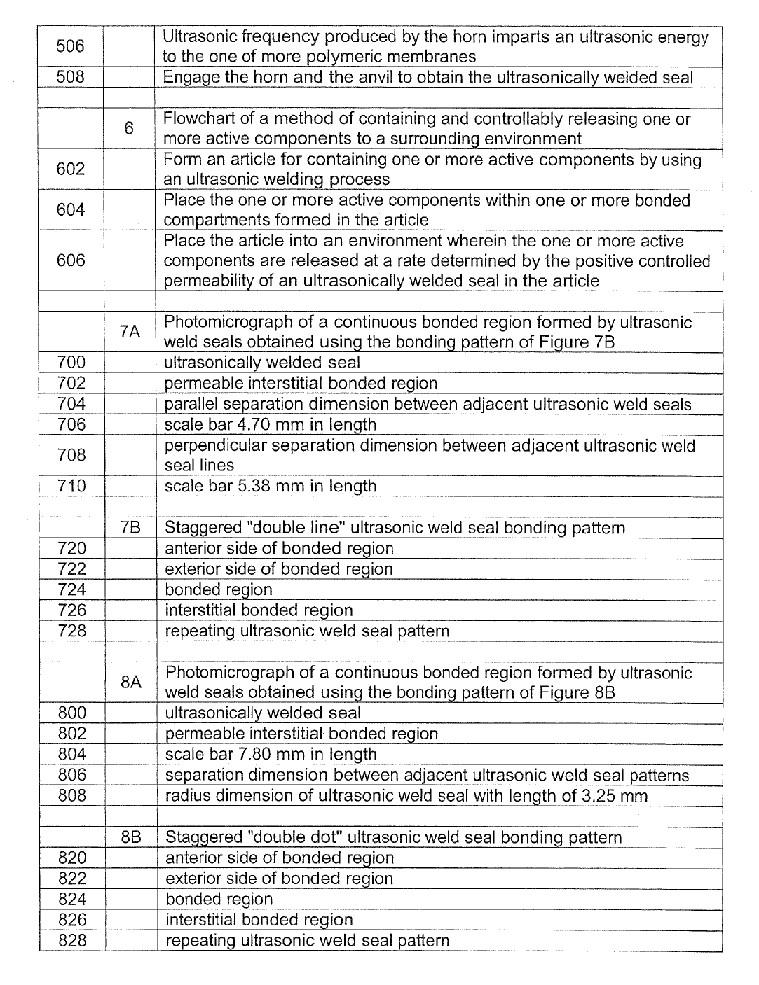

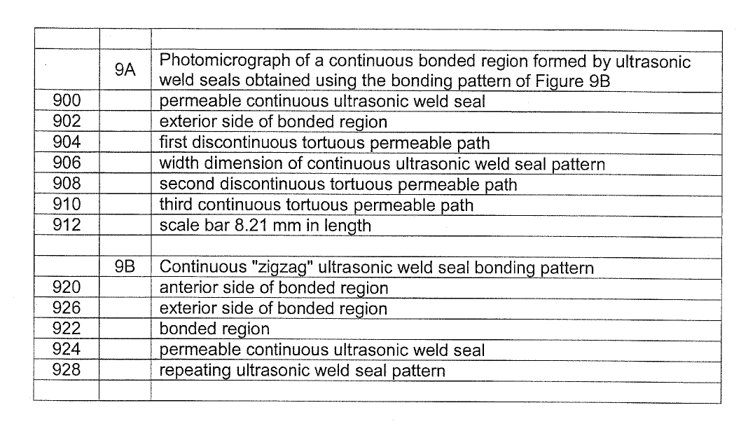

In an alternative embodiment, a permeable ultrasonic weld seal can be formed wherein a plurality of tortuous paths are created by the inventive process within a continuous ultrasonically welded seal. FIGS. 9A and 9B illustrate one such embodiment of a continuous bonded region formed by ultrasonically welded seals obtained using a continuous “zigzag” pattern to ultrasonically weld two polymeric membranes. The photomicrograph of FIG. 9A was taken in a similar fashion as the previous embodiments described hereinabove and focuses on a small linear segment of a permeable continuous ultrasonically welded seal 900. FIG. 9A and FIG. 9B, taken together, illustrate an example of one embodiment in which a continuous zigzag pattern is employed to form a permeable continuous ultrasonically welded seal 900 representing a contiguous, i.e. non-interrupted, weld seal that extends across bonded region 922. Bonded region 922 consists of an anterior side of bonded region 920 and an exterior side of bonded region 926 that both communicate with permeable continuous ultrasonic weld seal 924 on a first anterior side and a second exterior side, respectively.

This embodiment illustrates bonded region 922 wherein permeability of a permeable continuous ultrasonically welded seal 900 is defined by a plurality of individual tortuous paths produced in an essentially random pattern across the width of the ultrasonic weld having a width dimension 906. In this embodiment the width dimension is represented by scale bar 912, having a value of approximately 8.21 mm. The plurality of individual tortuous paths are represented here by a first tortuous path 904, a second tortuous path 908 and a third tortuous path 910 that extend from an anterior side of bonded region 920 to an exterior side of bonded region 926. Additional tortuous paths produced during the ultrasonic welding process according to methods of the present invention are not visible in the photomicrograph of FIG. 9A, but contribute to the overall permeability of the permeable continuous ultrasonically welded seal 900 in enabling controlled diffusion of a selected active substance. In this present embodiment, two polymeric membranes of Dupont Tyvek™ HomeWrap® sheeting were welded according to the methods of the present invention by employing a repeating ultrasonic weld seal pattern to form a bonded compartment.

Without being bound by theory, it is believed that in this and similar embodiments employing a continuous weld seam, selection of the welding parameters, including applied ultrasonic energy level, duration of applied energy and anvil to horn application pressure, may be optimally employed so as to produce incompletely bonded ultrasonic weld seals that are sufficiently porous in nature owing to a plurality of microscopic tortuous free paths that enable permeation of liquid and gaseous substances to pass through the imperfectly bonded region of the ultrasonic weld seam. Despite the porosity of the weld seams produced by the methods of the present invention, the welds are of sufficient bonding strength to secure the bonded polymeric membranes in bonded configuration to prevent physical separation or rupture of bonded regions of an article, even when significant internal pressures inside a bonded compartment are generated during use of gas or vapor releasing substances or composition within bonded compartments.

In these and other embodiments of the invention, the positive permeability of a finished article may be controlled by appropriate selection of the welding pattern, welding pattern size and spacing, extent of permeable weld seal region, and ultrasonic welding process parameters to generate an article having the desired permeability with respect to one or more substances or reactive products generated by substances within one or more bonded compartments of a finished article, by correlating to a Bubble Test Method parameter that measures positive permeability of a formed article, as described in the ‘Tests and Examples’ section.

### Construction of Article

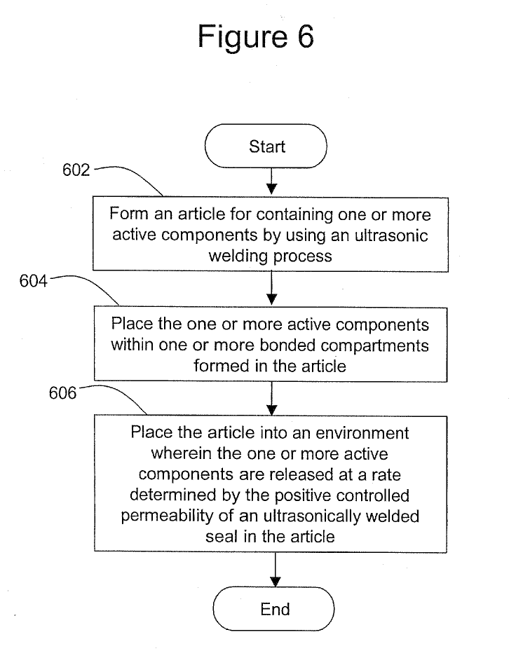

FIG. 6 is a flowchart of a method of containing and controllably releasing one or more active substances to a surrounding environment. At operation 602, an article for containing one or more active substances is formed by using the ultrasonic welding process. The article features one or more polymeric membranes that feature one or more polymeric materials, and at least one ultrasonically welded seal. The at least one ultrasonically welded seal forms a bonded region in the one or more polymeric membranes. The at least one ultrasonically welded seal allow the one or more active substances to permeate through the bonded region with a positive controlled permeability. At operation 604, the one or more active substances are placed within one or more bonded compartments formed in the article prior to completion or formation of the at least one ultrasonically welded seal. Alternatively, in another embodiment, the one or more active substances are placed within one or more bonded compartments formed with completed permeable ultrasonically welded seals according to the methods of the present invention where such compartments however further feature at least one non-bonded segment in the welded seal region through which the active substances can be transferred into the partially formed bonded compartments prior to final bonding. In one embodiment, the incomplete non-bonded segment is then welded by formed a conventional ultrasonic non-permeable weld seal that effectively seals the active material within the bonded compartment, isolating it from the exterior environment, through which further communication is then limited by means of the permeable ultrasonically bonded seal produced prior to filling of the bonded compartment with the active substance. In another embodiment, other respective bonded compartments formed with incomplete bonding regions having at least one non-bonded segment are filled with their respective active substances in a similar manner. In another embodiment, a plurality of compartments are filled with a plurality of individual active substances simultaneously prior to final sealing of the respective compartments to isolate their respective actives from the exterior environment.

At operation 606, the article is kept in an environment whereby the one or more active substances are released from each of the one or more bonded compartments at a rate determined by the positive controlled permeability of each respective bonded region formed by the at least one ultrasonically welded seal.

The method for manufacturing an article capable of storing and controllably releasing one or more active substance includes controlling the process parameters of the ultrasonic welding station. Further, the method also includes controlling one or more selected bonding patterns on the horn and the anvil of the ultrasonic welding station. The permeability of the article is tested using the Bubble Test method described in the ‘Tests and Examples’ section.

The various embodiments of the present invention provide the following advantages. One of the advantages is to provide controlled permeation of active substances contained in articles or pouches, to a desired point of use. This permeation allows effective and required amounts of active substances to be delivered at the desired point of use. Further, the present invention does not require any manual participation for controlling the permeation of the active substances. Another advantage of the present invention is to provide controlled permeation of active substances at a predetermined rate. Yet another advantage of the present invention is that the permeation characteristics of the active substances are controlled without affecting the strength of ultrasonically welded seals used to bond the articles or pouches. Further, the articles or pouches allow active substances in the form of gases, solids, solutions and liquids to be stored and permeated with controlled diffusion rate, for delivery to the point of use. The article can also be used for filtering of a gas, liquid, vapor, and combination thereof.

### TESTS AND EXAMPLES

### Bubble Test Method

The Bubble Test method provides a means for quantifying positive controlled permeability of an ultrasonically welded seal.

Actual determination of the permeability coefficient of an active substance across an ultrasonically welded seal of an article is difficult to measure, particularly when low permeability is selected or an active substance is employed whose release rate is difficult to quantitatively determine. Accordingly, use of actual permeation rates of an active substance to provide feedback for setting of manufacturing and process parameters to produce the desired ultrasonically welded seal according to the present invention is generally cumbersome. To address this, the Bubble Test method is employed to more readily characterize the positive controlled permeability of the article, using a method that is easy to use during production and process control, so as to provide quick feedback to enable nearly real-time process control and setting of manufacturing and process parameters during manufacturing of the article. The Bubble Test method measurements can also be correlated against other test data, including for example a diffusion rate measurement of an active substance determined by some other means known in the art, to provide a means for optimizing and selecting process parameters for control of the ultrasonic welding process to achieve a desired positive permeation of a finished article with respect to the one or more active substances contained within one or more bonded compartments.

Following is a description and test method steps of the Bubble Test. The purpose of the test is to measure air permeation rate from trapped air within a test article comprising polymeric membranes bonded by the ultrasonic welding process of the present invention.

Apparatus required includes a vacuum pump, a bubble tester, a stop watch and optionally a video capture device or human operator to observe and count bubbles. A bubble tester is any closeable container that can releasable hold water, one or more test articles and has at least one transparent wall or window enabling observations of the interior space, and which may be depressurized to a value of about 5 torr with respect to atmospheric standard pressure. In one embodiment, a Nalgene vacuum desiccator of polycarbonate construction available from Cole-Parmer Instruments, Vernon Hills, Ill. is employed as a bubble tester

### Procedure:

1. Seal the test article with a selected bonding pattern based on a first set of values of process parameters of the ultrasonic welding process, the article is sealed with a trapped air volume at predefined pressure. One or more similar pouches may be used for replicate purposes.

2. Remove covering of the bubble tester and fill with sufficient tap water to completely submerge the test article.

3. Submerge the prepared test article into the bubble tester, and if necessary keep it submerged using some weight.

4. Close and seal the bubble tester and connect the vacuum pump to the bubble tester.

5. Switch on the vacuum pump and observe the rate of release of air bubbles from the submerged test article using the stop watch.

6. Repeat steps 2-5 if necessary.

Despite the apparent simplicity of the Bubble Test, sacrificial test articles could rapidly be evaluated and used to adjust manufacturing and process parameters to produce multiple finished articles of very uniform characteristics matching a desired positive permeability for a selected active substance.

In the given embodiments of the present invention, the preferred range of the positive controlled permeability is greater or equal to about 1 bubble/30 seconds per linear inch of the bonded region (about 0.033 bubble-inch per second) and less than about 100 bubbles/30 seconds per linear inch of the bonded region (about 3.33 bubble-inch per second). A positive controlled permeability of less than about 0.033 bubble-inch per second may be achieved by relying on the characteristic permeation of the polymeric membrane itself, when such a permeable membrane material is optionally selected for use. A positive controlled permeability greater than about 3.33 bubble-inch per second is generally found to be too leaky to provide the most optimum controlled permeation. However, in other embodiments of the invention, depending on the characteristics of the active substance, the positive controlled permeability of the article can vary from these rates.

### Peel Test Method

The bonding strength of the ultrasonically welded seal with a controlled permeability produced using the ultrasonic welding process has excellent bonding strength with respect to forming an article with ultrasonically welded seams being resistive to failure. To measure bonding strengths, a Peel Test method was developed that provides numeric peel resistance measurement values that can be used to adjust manufacturing and process parameters according to the present invention.

The Peel Test method can use any device capable of gripping and pulling apart a two layered test sample. An Instron Model 5565 was employed using opposed 2′ finger grip jaws in the upper and lower mandrels that were drawn apart at a constant rate while measuring peak (maximum) load in pounds of force (lbf) and energy at maximum peel extension in pounds of force per inch (in-lbf). A sacrificial test strip of two polymeric membranes bonded along the two longest sides (lengthwise) of an approximately 3 inch by 12 inch double layered test article is prepared using the desired repeating ultrasonic bond weld seal pattern to produce a continuous bonded region of approximately 10 inches in length along the two sides of the test article, and inwardly offset by about 0.50 inches from the edge, using the manufacturing and process control parameters to be evaluated for peel strength determination. This produces a test article that has two bonded regions running lengthwise, separated across the smallest side (widthwise) of the test article by about 2 inches, the two continuous bonded regions each being about 0.50 inches from each edge to minimize any edge effects during peel test strength determination. This produces a test article having two unbonded tongues of the polymeric membranes of about 2 inches in length that are sufficient in length so as to be gripped independently by the opposed finger grip jaws so that displacement of the mandrels will result in a perpendicular applied displacement force to the longitudinal welded seams of the test article, tearing it lengthwise from the unbonded end lengthwise along the bonded seam until the two polymeric membranes are nearly fully separated from one other. An ASTM 2737M 5.6 bond strength protocol was used on the instrument for numerical analysis, the mandrels displaced at a rate (strain rate) of about 12 inches/minute. Typically, about seven replicates produced under identical conditions are measured and an average value determined for the set.

Following are the method steps of carrying out the Peel Test. The purpose of the Peel Test Method is employed to readily characterize the strength of the welded seal of the article. The Peel Test method may be used during production and process control of making the ultrasonically welded seal, so as to provide a feedback to enable nearly real-time process control and adjustment of process parameters during the manufacturing of the article, enabling control to obtain both the desired positive permeability of the finished articles and an acceptable bonding strength for bond stability and integrity of the finished article during manufacture, storage, transportation to point of use.

Test strips prepared according to the “double line” repeating ultrasonic weld pattern described in FIGS. 7A and B resulted in bonds exhibiting mean maximum load peel strengths of greater than about 3 lbf with a mean energy at maximum peel extension of greater than about 7 lbf. In other embodiments, mean maximum load peel strengths in excess of 7 lbf were produced, and mean energy at maximum peel extension of greater than about 16 in-lbf were produced. Similar ranges were measured for a test strip employing the “double dot” embodiment illustrated in FIGS. 8A and B. Both results confirm a bond peeling strength comparable to a non-inventive ultrasonic weld seam, yet having a positive permeability characteristic owing to employing the inventive method as described herein. Test strips prepared according to the continuous “zigzag” repeating ultrasonic weld pattern described in FIGS. 9A and B were also measured. Test results revealed mean maximum load peel strengths of greater than about 5 lbf with a mean energy at maximum peel extension of greater than about 10 lbf. In other embodiments, mean maximum load peel strengths in excess of about 6 lbf were produced, and mean energy at maximum peel extension of greater than about 14 in-lbf were produced.

While the preferred embodiments of the present invention have been described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. An article for controllably releasing an active substance, the article comprising:
a. one or more polymeric membranes comprising one or more polymeric materials;
b. at least one ultrasonically welded seal, wherein the at least one ultrasonically welded seal forms a bonded region in the one or more polymeric membranes, the at least one ultrasonically welded seal having a positive controlled permeability for the active substance; and
c. optionally, one or more active substances,
wherein movement of the active substance across the at least one ultrasonically welded seal defines the positive controlled permeability for the active substance.

2. The article of claim 1, wherein the at least one ultrasonically welded seal comprises a plurality of tortuous free paths within the bonded region in the one or more polymeric membranes, the plurality of tortuous free paths allowing the movement of the active substance across the at least one ultrasonically welded seal within the bonded region exhibiting the positive controlled permeability in the range of about 0.033 bubble-inch per second to less than about 3.33 bubble-inch per second according to a Bubble Test Method.

3. The article of claim 1, wherein the one or more polymeric membranes are bonded to comprise at least one continuous bonded region providing at least one bonded compartment for containing at least one active substance.

4. The article of claim 1, wherein the one or more polymeric membranes are bonded to comprise one or more continuous bonded regions providing a plurality of bonded compartments for containing one or more active substances, wherein one or more of the plurality of bonded compartments selectively contains the one or more active substances individually or in any desired combination thereof.

5. The article of claim 4, wherein the at least one ultrasonically welded seal adjoining two or more adjacent bonded compartments forms an adjacent bonded region, the at least one ultrasonically welded seal being non-permeable with respect to the one or more active substances contained within the two or more adjacent bonded compartments sharing the adjacent bonded region, and wherein non-adjacent bonded regions of the two or more adjacent bonded compartments comprise ultrasonically welded seals having positive controlled permeability with respect to the one or more active substances.

6. The article of claim 1, wherein the one or more polymeric materials are selected from the group consisting of polyethylene terephthalate (PET), polyamide, polyurethane (PU), polyester (PES), polyethylene (PE), polyvinyl chloride (PVC), chlorinated polyvinylidene chloride (CPVC), polyacrylamide (PAM), polystyrene (PS), polypropylene (PP), polycarbonate (PC), polyaryletherketone (PEK), poly(cyclohexylene dimethylene cyclohexanedicarboxylate), poly(cyclohexylene dimethylene terephthalate), poly(cyclohexylene dimethylene terephthalate) glycol, polyetherimide, polyethersulfone, poly(ethylene terephthalate) glycol, polyketone (PKO), poly(oxymethylene), polyformaldehyde, poly(phenylene ether), poly(phenylene sulfide), poly(phenylene sulfone), polysulfone, polytetrafluoroethylene (PTFE), poly(vinylidene fluoride), polyamide thermoplastic elastomer, polybutylene, polybutylene terephthalate, polypropylene terephthalate, polyethylene naphthalate (PEN), polyhydroxyalkanoate, polyacrylate (PAA), poly(methyl)methacrylate (PMMA), polytrimethylene terephthalate, polyvinylidene chloride, Tyvek™ and combinations thereof, and copolymeric materials made of one or more monomers selected from acrylate, acrylonitrile, butadiene, ethylene, formaldehyde, maleic anhydride, melamine, methacrylate, methyl methacrylate, phenol, propylene, styrene, urethane, and vinyl acetate, and combinations thereof.

7. The article of claim 1, wherein the one or more polymeric membranes have an effective pore size in the range of about 0.01 micrometers to about 100 micrometers.

8. The article of claim 1, wherein the active substance is in the form of at least one of a gas, a saturated vapor, a liquid, a solid, a particulate and a solution.

9. The article of claim 8, wherein the active substance is selected so as to provide said article the controlled positive permeability with respect to at least one of a gas, saturated vapor, a liquid and a solution.

10. The article of claim 1, wherein the positive controlled permeability of the active substance across the at least one ultrasonically welded seal is activated by at least one of environmental factors and chemical factors.

11. The article of claim 1, wherein the at least one ultrasonically welded seal has the positive controlled permeability for the active substance, the movement of the active substance across the at least one ultrasonically welded seal providing a single mode permeation of the active substance.

12. The article of claim 1, wherein the one or more of the plurality of the polymeric membranes have a selected membrane permeability for the active substance, and the at least one ultrasonically welded seal has positive controlled permeability for the active substance, the movement of the active substance across the at least one ultrasonically welded seal and across the one or more of the polymeric membranes providing a multiple mode permeation of the active substance.

13. The article of claim 1, wherein at least two of the plurality of the polymeric membranes have a first and second selected membrane permeability for the active substance, and the at least one ultrasonically welded seal has positive controlled permeability for the active substance, the movement of the active substance across the at least one ultrasonically welded seal and across the one or more polymeric membranes providing a multiple mode permeation of the active substance.

14. The article of claim 1, wherein a plurality of ultrasonically welded seals form two or more bonded regions defining at least one bonded compartment for containing the active substance, and wherein at least two of the plurality of ultrasonically welded seals with different positive controlled permeability form at least one bonded region, the movement of the active substance across the at least two of the plurality of ultrasonically welded seals providing a multiple mode permeation of the active substance.

15. A method for producing an article for controllably releasing an active substance, the method comprising:
a. using one or more polymeric membranes for forming one or more of bonded regions, the one or more bonded regions defining at least one bonded compartment, the at least one bonded compartment providing an enclosed interior volume for containing the active substance; and
b. bonding parts of two or more of the one or more polymeric membranes to obtain an ultrasonically welded seal using an ultrasonic weld station, wherein the ultrasonically welded seal has a positive controlled permeability for the active substance.

16. The method of claim 15, wherein the bonding operation (b) comprises selecting suitable process parameters of the ultrasonic weld station, the process parameters being at least one of bonding pattern, weld energy, energy density, duration of welding, and weld speed.

17. The method of claim 15, wherein the bonding operation (b) comprises creating a plurality of tortuous free paths between the one or more polymeric membranes, the plurality of tortuous free paths allowing movement of the active substance across the ultrasonically welded seal.

18. The method of claim 15, wherein the bonding operation (b) comprises producing the ultrasonically welded seal with a uniform positive permeability for the active substance.

19. The method of claim 15, wherein the bonding operation (b) comprises producing the ultrasonically welded seal with a non-uniform positive permeability for the active substance.

20. A method for producing an article for controllably releasing an active substance, the method comprising:
a. using one or more polymeric membranes to create a bonded compartment defining an enclosed interior volume for containing the active substance;
b. feeding the one or more polymeric membranes between an anvil and a horn of an ultrasonic weld station;
c. producing an ultrasonic frequency imparting an ultrasonic energy to the one or more polymeric membranes, the ultrasonic frequency being produced by the horn; and
d. engaging the horn and the anvil to obtain an ultrasonically welded seal, wherein the ultrasonically welded seal bonds parts of the one or more polymeric membranes, the ultrasonically welded seal having a positive controlled permeability for the active substance.

21. A method of containing and controllably releasing one or more active substances to a surrounding environment comprising:
a. forming an article containing one or more active substances, wherein the article comprises one or more polymeric membranes comprised of one or more polymeric materials, and at least one ultrasonically welded seal, wherein the at least one ultrasonically welded seal forms a bonded region in the one or more polymeric membranes, the at least one ultrasonically welded seal having a positive controlled permeability for the one or more active substances, wherein movement of the one or more active substances across the at least one ultrasonically welded seal defines the positive controlled permeability of the one or more active substances;
b. placing the one or more active substances within one or more bonded compartments formed in the article; and
c. placing the article into an environment whereby the one or more active substances are released from each of the one or more bonded compartments at a rate determined by the positive controlled permeability of each respective bonded region formed by the at least one ultrasonically welded seal.
